(19) United States
(12) Patent Application Publication
(10) Pub. No.: US 2007/0038850 A1
(43) Pub. Date: Feb. 15, 2007

(54) System boot and resume time reduction method

(76) Inventors: Jeanna N. Matthews, Massena, NY (US); Sanjeev N. Trika, Hillsboro, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/201,494

(22) Filed: Aug. 10, 2005

(51) Int. Cl. G06F 15/177

(52) U.S. Cl. 713/1

(57) ABSTRACT

A system and method to reduce the time for system initializations is disclosed. For at least one embodiment, data accessed during a system initialization is loaded into a non-volatile cache during shutdown or entry into a low-power mode. On a subsequent boot, or resumption after a low power mode, the data required for system initialization has already been pre-loaded into the cache, thereby eliminating the need to access a disk. Other embodiments are also described and claimed.

### FIELD

The invention relates to computing systems, and more particularly, to a non-volatile cache used in a system.

### BACKGROUND DESCRIPTION

The use of a cache with a processor reduces memory access time and increases the overall speed of a device. Typically, a cache is an area of memory which serves as a temporary storage area for a device. Data frequently accessed by the processor may remain in the cache after an initial access; subsequent accesses to the same data may be made to the cache.

Caching data from the disk drive in volatile memory is common practice. A volatile memory cache, sometimes known as cache store, is typically a high-speed memory device such as a static random access memory (SRAM). A copy of data from a cached device such as a disk is stored in the volatile memory cache. If it is accessed again, the data can be retrieved from the faster volatile memory copy rather than from the slower cached device. This is effective because most programs access the same data or instructions repeatedly.

Non-volatile memory caching works under the same principle as volatile memory caching but uses a non-volatile memory device instead of a volatile memory device. The most recently accessed data from a cached device is stored in the non-volatile cache. Furthermore, writes may be sent to the non-volatile memory cache without being sent also to the cached device without risk of data loss due to crashes or power failures. When a program needs to access data from the cached device, the non-volatile cache is first checked to see if the data is present. As with volatile caches, this is effective because accessing a byte of data in non-volatile memory can be much faster than accessing a byte on the cached device, such as a disk. For example, a sequence of disk accesses required to load an operating system and launch system services is predictable. As a result, this initialization data can be brought into a disk cache during normal operation for faster access. For example, having such initialization data in the disk cache can improve (i.e., reduce) the time needed to re-boot after shutdown or to “resume” after hibernation.

However, the size of a cache is limited and is generally used to store the most recently used data. Accordingly, storage of the initialization data in a non-volatile disk cache during run-time, rather than only upon boot or “resume” after hibernation, may require special processing. Such an approach may be useful in order to keep initialization data resident in the cache for fast access during system initialization, thereby avoiding accesses to the disk. For example, one such approach is described in co-pending patent application Ser. No. 09/894,310, “System Boot Time Reduction Method,” filed Jun. 27, 2001. Described therein is a method for “pinning” boot/resume data so that it is not evicted from a non-volatile disk cache during runtime processing.

### BRIEF DESCRIPTION OF THE DRAWINGS

Embodiments of the present invention may be understood with reference to the following drawings in which like elements are indicated by like numbers. These drawings are not intended to be limiting but are instead provided to illustrate selected embodiments of systems and methods for reducing system initialization time using a non-volatile cache.

FIG. 1 is a block diagram of at least one embodiment of a system capable of performing disclosed techniques.

FIG. 2 is a state diagram illustrating at least one embodiment of a method for recording a boot set and for loading boot data into a non-volatile cache before entering into a low-power state.

FIG. 3 is a flowchart illustrating at least one embodiment of a method that may be performed during a booting state.

FIG. 4 is a flowchart showing at least one embodiment of a method that may be performed during a pre-shutdown processing state.

FIG. 5 is a block diagram of at least one embodiment of a method that may be performed for a subsequent reboot.

### DETAILED DESCRIPTION

The following discussion describes selected embodiments of methods and systems for reducing boot and resume time of a system having a non-volatile cache. In the following description, numerous specific details have been set forth to provide a more thorough understanding of embodiments of the present invention. It will be appreciated, however, by one skilled in the art that the invention may be practiced without such specific details. Additionally, some well known structures, circuits, and the like have not been shown in detail to avoid unnecessarily obscuring the present invention.

In the following discussion, references to “one embodiment”, “an embodiment”, “example embodiment”, “various embodiments”, etc., indicate that the embodiment(s) of the invention so described may include a particular feature, structure, or characteristic, but not every embodiment necessarily includes the particular feature, structure, or characteristic. Further, repeated use of the phrase “in one embodiment” does not necessarily refer to the same embodiment, although it may.

As disclosed herein, a “cache” refers to a temporary storage area and may be either a volatile or non-volatile memory cache. The term “data” refers to both data and instructions that can be stored in a cache. A “disk” refers to a hard disk drive, a floppy disk drive, a compact disc (CD) drive or any other memory device, including magnetic and/or optical memory devices, for mass storage of data.

Various embodiments of the invention discussed herein provide for recording which data is utilized on system initialization, and for loading such data into a non-volatile cache during a power-down in order to make it available in the cache for a subsequent system initialization. As used herein, the term “system initialization” refers to any of several types of power-on events. For example, the term may refer to a system boot when operational power of a processor is cycled from off to on, known as cold booting. Also, for example, the term may refer to a system reboot when a system is restarted, known as warm booting. Also, for example, the term may refer to resumption of processing upon exiting from a low-power mode such as “sleep” mode, “hibernation” mode, “deep sleep” mode, “standby” mode, and the like. For purposes of the explanation, the terms “system initialization” and “boot” are used interchangeably herein to generally refer to any of the power-on events explicitly indicated above as well as to any other similar situations.

Similarly, the term “power-down” as used herein may also refer to any of several types of power-down events. For example, the term may refer to removal of operational power from the system. Also, for example, the term may refer to entry of a lower-power mode such as sleep, hibernate, etc. Also, for example, the term may also refer to exit of full operating mode responsive to a hibernate, shutdown, or a warm boot (“restart”) stimulus. For purposes of the explanation, the term “power-down” is used herein to generally refer to any of the power-down events explicitly indicated above as well as to other similar situations.

The time required to reload an operating system and restart system services is a visible source of irritation to users. Much of this time is often devoted, in common systems, to reading the initialization data from a disk. Generally, embodiments of the present invention provide a system and method to load into a non-volatile storage media the data expected to be needed during a system initialization. The sequence of data read from a disk during system start-up or initiation is recorded during the start-up or initiation process as a “boot set.” Subsequent boot time is reduced by having the boot set data pre-loaded into a non-volatile cache as the system is powering down. In this manner, boot set data will be available in the cache upon the subsequent system initialization sequence, thereby reducing boot time.

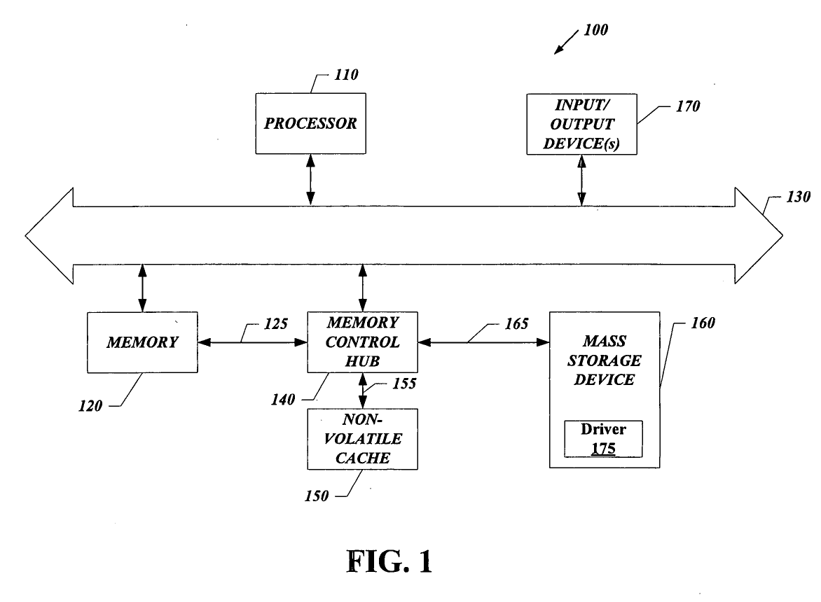

A sample embodiment of a system 100 to implement at least one embodiment of the invention is shown in FIG. 1. Computing system 100 is intended to represent any number of computing and communication systems, including, but not limited to, mainframes, minicomputers, servers, workstations, personal computers, notepads, personal digital assistants, and various wireless communication devices that may include one or more optional antenna(e) and/or embedded systems, just to name a few.

The system 100 includes a processor 110 coupled to a volatile memory 120 (hereinafter “memory”) by a communication pathway 130. In one embodiment, the memory 120 is a dynamic random-access-memory (DRAM). Also coupled to the communication pathway 130, a memory control hub 140 controls the operations of the memory 120 via link 125, a non-volatile cache 150 (hereinafter “cache”) via link 155 and a cached device 160 via link 165. For at least one embodiment, the cached device 160 may be a disk as described above.

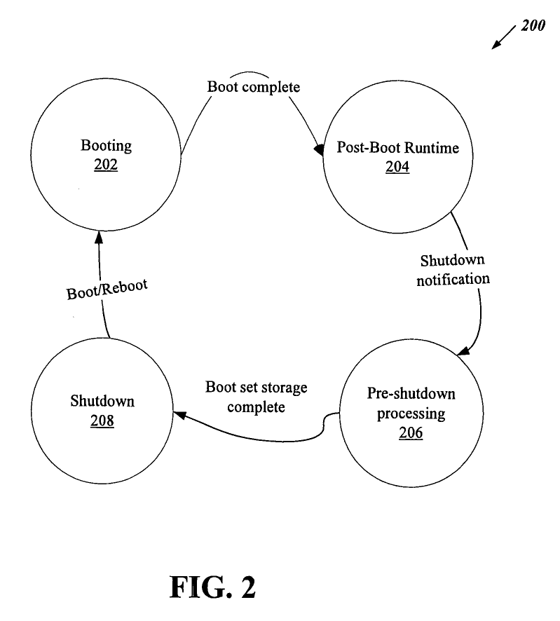

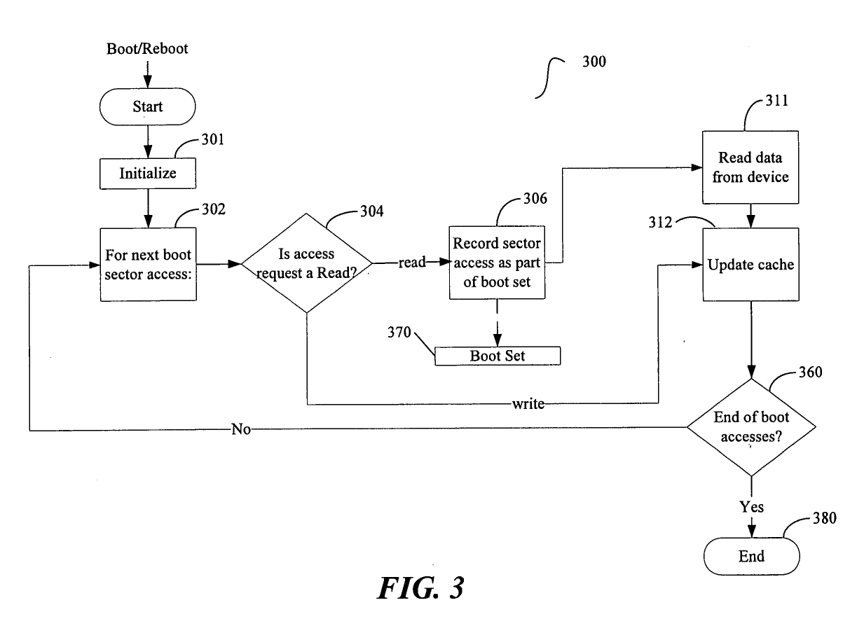

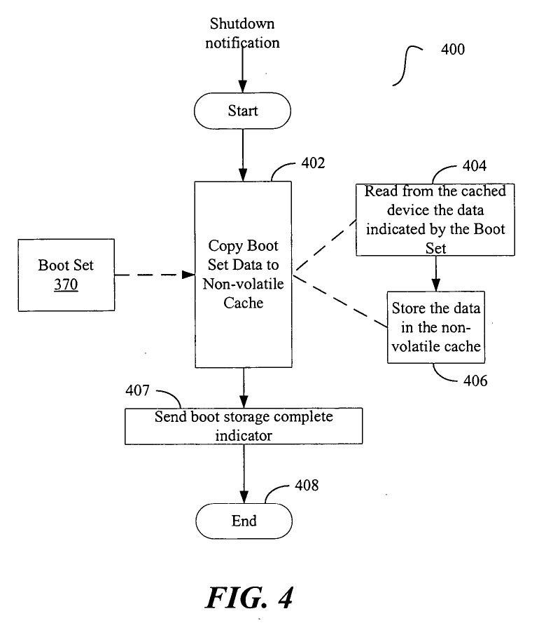

The system 100 is capable of performing the method 200 illustrated in FIG. 2 (discussed below) and includes a driver capable of performing the methods 300, 400, also discussed below, which are illustrated in FIGS. 3 and 4, respectively.

Although the driver may be implemented in various manners for various embodiments, an example driver is illustrated in FIG. 1 as a software driver 175 stored in the cached device 160. For such embodiment, the cached device 160 may be a hard disk drive. The example embodiment for the driver 175 shown in FIG. 1 should not, however, be taken to be limiting. Although many drivers are commonly implemented in software, it should be understood that the use of the term “driver” herein is intended to encompass any logic, including software, hardware, firmware, or a combination thereof, for performing the operations discussed herein.

The memory control hub 140 may include a logic circuit (not shown) to manage the state or metadata information of memory 120 and the cache 150. Moreover, it will be appreciated by those skilled in the art that the memory control hub 140 may also include additional circuits to control caching functions such as read, write, update, and invalidate operations. Finally, one or more input/output devices 170 such as a keyboard, mouse and/or display may be coupled to the communication pathway 130.

Although the system 100 is shown as a system with a single processor, the invention may be implemented with multiple processors, in which additional processors are coupled to the communication pathway 130. In such case, each additional processor may share the cache 150 and memory 120 for writing data and/or instructions to and reading data and/or instructions from the same.

Also, the system 100 shows the cache 150 to be a non-volatile storage media. However, the cache 150 may be a combination of volatile and non-volatile storage media. Similarly, the memory 120 may be one or any combination of a volatile storage media and a non-volatile storage media. Moreover, the cache 150 may be implemented into the system 100 as an add-in card such as a peripheral component interconnect (PCI) add-in. In still another embodiment, a portion of the disk 160 may be allocated as the cache 150.

One or more of links 125, 155 and 165, as well as communication pathway 130, may be a multi-drop bus. Alternatively, any or all of these elements 125, 155, 165, 130 may be a point-to-point interconnect.

In one embodiment, data utilized during system initialization is recorded as part of a “boot set”. During a shutdown, the boot set is loaded into a non-volatile cache 150. On subsequent system initialization, the initialization data loaded into the non-volatile cache during the previous system shutdown is already loaded into the cache 150 and is therefore available to support speedier system initialization.

During each initialization sequence, a procedure is performed to identify that data that is accessed during the system initialization. The desire to improve system boot performance and the desire to keep majority of space in the cache 150 free or replaceable during normal operation should be balanced. Accordingly, the system initialization data is not forced, through pinning or some other mechanism, to remain in the cache 150 during normal operation of the system 100. Instead, the system initialization data is loaded into the cache 150 during a shutdown sequence, so that it will be available in the cache 150 during a subsequent system initialization sequence.

FIG. 2 shows a sample state transition diagram that generally illustrates the states for a method 200 according to at least one embodiment of the present invention. FIG. 2 illustrates states 202, 204, 206, 208 for a system, such as a system 100 as illustrated in FIG. 1.

FIG. 2 illustrates that a first state, referred to in FIG. 2 as a “booting” state 202, is entered when a system initialization trigger is received. The system initialization trigger is referred to in FIG. 2 as a “boot/reboot” indicator. The boot/reboot indicator triggers a transition from a low-power mode to a full-power mode. Such system initialization trigger may be, for example, a hard power cycle from “off” to “on”. In addition, the system initialization trigger may be receipt of an indicator that specifies that processing is to be resumed from a low-power state such as “standby”, “sleep”, “hibernate”, or the like. In addition, the system initialization trigger may be a restart, warm start, or soft power cycle indicator.

During the booting state 202, system initialization processing may be performed. For at least one embodiment, a boot set may be determined during the system initialization processing. At least one embodiment of a method that may be performed during the booting state 202 to determine a boot set is discussed in further detail below in connection with FIG. 3.

FIG. 2 illustrates that a system may transition from the booting state 202 to a post-boot runtime state 204. Such transition may occur upon completion of system initialization processing. Completion of system initialization processing is referred to in FIG. 2 as “boot complete.”

During the post-boot runtime state 204, normal run-time processing is performed. During such state 204, information may be provided to or requested from a cached device. For at least one embodiment, such information may be provided to or requested from a device driver associated with the cached device (see, e.g., cached device 160 and driver 175 of FIG. 1).

The requested information may be written to or read from the cache 150. Upon a read for example, the device driver may return the requested read data from the cache 150 if the data is present in the cache. In this manner, when data is read the device driver may return the data from the cache, 150, if possible, to avoid a cached-device request. Similarly, the device driver may buffer write data in the cache 150 instead of writing to the cached device for every write request.

Thus, during the post-boot runtime state 204, the cache 150 is fully available to store other data utilized during runtime processing. Any boot data in the cache 150 may be evicted during the post-boot runtime state 204 in order to make way for other data. Such eviction may include a writeback to the cached device if the line to be evicted from the cache 150 is determined to be “dirty.”

FIG. 2 illustrates that, for at least one embodiment, a transition out of the post-boot runtime state 204 may be triggered by a shutdown notification. Such shutdown notification may be a hard power cycle from on to off, or may be receipt of an indicator that specifies entry into a low-power state such as “standby”, “sleep”, “hibernate”, or the like.

FIG. 2 further illustrates that the shutdown notification may cause a transition out of the boot runtime state 204 into a “pre-shutdown processing” state 206. The pre-shutdown processing state 206 is a state during which, for at least one embodiment, the data of the boot-set is loaded into the non-volatile cache prior to shutdown. At least one embodiment of a method that may be performed during the pre-shutdown processing state 206 is discussed in further detail below in connection with FIG. 4.

A transition from the pre-shutdown processing state 206 may occur upon completion of loading of the boot set data to the non-volatile cache. Accordingly, FIG. 2 illustrates that such transition is triggered by “boot set storage complete” and causes entry into a shutdown state 208. During such shutdown state 208, the system is either off or is in a low-power mode. The shutdown state 208 illustrated in FIG. 2 is thus intended to represent any low-power state, including a completely powered-down “off” state. Other modes represented by the shutdown state 206 may include “sleep”, “deep sleep”, “standby”, “hibernate”, and the like.

FIG. 3 is a flowchart illustrating at least one embodiment of a method 300 that may be performed during a system initialization. For at least one embodiment, the method may be performed by software. Such software may be, for example, a driver associated with a cached device (see, e.g., 175 of FIG. 1). The method 300 may be performed during a boot state, such as boot state 202 illustrated in FIG. 2.

Generally, the method 300 shown in FIG. 3 includes recording the location of all data read from a cached device (see, e.g., 160 of FIG. 1) during a system initialization. FIG. 3 illustrates that the method 300 may be triggered by a boot/reboot indicator such as that discussed above in connection with FIG. 2.

As part of the boot process, the driver associated with the cached device may be initialized (block 301). During initialization at block 301, the driver may clear out any previously-recorded disk sector coordinates from the boot set. As the system boots, it may request (block 302) access to boot data from the cached device. For example, such requests 302 may be made by the operating system, basic input/output system (BIOS), an operating system boot loader, or the like. The foregoing list of examples is for illustrative purposes only, and should not be taken to be limiting.

FIG. 3 illustrates that for each boot sector access requested of the driver during system initialization, the method 300 determines at block 304 whether the access is a read or a write. If the access is a read, processing proceeds to block 306. Otherwise, if the access is a write, processing proceeds to block 312.

At block 306, the read access is recorded. For at least one embodiment, the access is recorded as a location coordinate to identify a memory location in the cached device. For example, the access may be recorded as a disk sector identifier that includes a pair of data: sector start address and data length. The sector start address may, for example, be a logical block address.

The access may be recorded at block 306 as part of the boot set 370. For at least one embodiment, the boot set 370 is stored in the non-volatile cache. The boot set 370 is thus a list of boot sectors read by the system during system initialization, and may be stored in any storage medium of the computer system.

If access to a particular sector is requested (block 302) multiple times during system initialization, it may only be recorded once in the boot set 370. Thus, subsequent accesses to the same boot set need not be recorded at block 306. If a neighboring sector has already been recorded in the boot set 370, the length component of the neighboring sector can be lengthened at block 306 to accommodate the adjoining sectors that are subsequently accessed. If the same data has already been previously read earlier during the same boot procedure, it has already been recorded in the boot set 370 and need not be recorded again. By the same token, if the data is already in the non-volatile cache but has not been recorded in the boot set 370, then the data is recorded in the boot set at block 306 so that it will be part of the data loaded into the non-volatile cache for a subsequent boot. From block 306, processing proceeds to block 311.

The requested read data is read at block 311. If the data is already in the cache, it is retrieved from the cache at block 311. In such case, processing proceeds from block 311 to block 360. If, however, the requested data is not already in the cache, the data is copied from the cached device at block 311. In such case, processing proceeds from block 311 to block 312.

For at least one embodiment, for the case that the requested read data is not in the cache, an entire cache line of data may be retrieved at block 311 in order to obtain the requested data; the requested data may be only a subset of the cache-line-sized block of data retrieved at block 311. The data retrieved from the cached device at block 311 may be stored in the non-volatile cache at block 312. For an embodiment that retrieves an entire cache line at block 311, rather than merely retrieving the requested data, the cache line of data retrieved at block 311 may be placed into the cache at block 312, in order to be available for subsequent access requests during system initialization. As is explained above, any data placed into the cache at block 312 during system initialization may be evicted during normal runtime processing. It is not pinned into the cache, and is permitted to be evicted during a post-boot runtime state (see, e.g., 204 of FIG. 2). Processing proceeds from block 312 to block 360.

FIG. 3 illustrates that, if it is determined at block 304 that the requested access is a write access, then processing proceeds from block 304 to block 312. That is, a write during system initialization is not, for at least one embodiment, recorded in the boot set 370. For at least one embodiment, only sectors that are read during system initialization are recorded in the boot set 370 at block 306. That is, data that is written during system initialization may be placed into the non-volatile cache without requiring a cached-device access. Pre-loading of write-only sectors into the non-volatile cache is therefore not necessary to ensure reduced boot time. Thus, write processing proceeds directly to block 312 from block 304, without recording the written sector in the boot set 370 (i.e., block 306 is skipped for a write). Of course, for at least one alternative embodiment, write accesses may also be recorded in the boot set 370 at block 306. For such alternative embodiment, the determination at block 304 need not be performed.

At block 312, the cache is updated with the write data. Processing then proceeds from block 312 to block 360. It should be noted that, although not shown in FIG. 3, one of skill in the art will recognize that data from the non-volatile cache may eventually be written to the cached device (such as, for example, in a writeback operation of a dirty cache line) or that the data from the non-volatile cache may be written to the cached device in parallel to being stored in the non-volatile cache.

At block 360, it is determined whether the end of the boot set has been reached. In various embodiments, such determination may be made in any of several manners. For one embodiment, a user-level utility can be configured to start once the machine is booted. For example, on systems the execute a WINDOWS operating system, this can be accomplished by placing the utility in the Startup Menu. When this utility starts, it can make a call into the driver signaling the end of the boot period. This allows the end of the boot period to be determined dynamically because the utility will not run until a) the operating system is fully booted, b) the desktop is displayed, and c) the programs on the Start Menu have been launched.

Alternatively, at block 360 it may be determined that the end of the boot set has been reached in the following manner: an end-of-boot delimiter may be consulted. Such delimiter may hard-coded or user-configurable. The delimiter value may, for example, specify a limit on the maximum number of requests that make up the Boot-Set. Alternatively, the delimiter value may, for example, specify how long in time the process of recording a boot-set should be allowed to take. For the former approach, beginning with the initialization, the driver can track cached device accesses until this limit is reached. A reasonable limit can be determined with experiments on the target operating system. The limit may also be a function of system variables, e.g., number of applications in the startup menu, and their sizes.

For at least one embodiment, the two above-mentioned methods of determining the end of the boot set may be employed in tandem. For such embodiment, the delimiter value may be used as a safeguard, to guarantee that the boot set processing will eventually end, even if an error prevents the user-level utility from running.

For another alternative embodiment, the end of the boot set may be determined at block 360 via the use of operating system hooks. That is, code may be inserted or implemented into the operating system such that the operating system notifies the driver when a power-up is complete.

For other alternative embodiments, one or more of the following approaches may be utilized to determine the end of the boot set at block 360: a user-triggered event; a drop in i/o (input/output) usage [that is, i/o usage below a minimum threshold amount] for a predetermined period of time; reaching a threshold number of i/o accesses during a boot; and reaching a maximum size for the boot set.

If it is determined at block 360 that the end of the boot set has been reached, then processing ends at block 380. Otherwise, processing loops back to block 302.

FIG. 4 is a flowchart illustrating at least one embodiment of a method 400 that may be performed to load system initialization data into a non-volatile cache (such as, for example, cache 150 shown in FIG. 1). FIG. 4 illustrates that the method 400 may be performed during a pre-shutdown processing state, such as pre-shutdown processing state 206 illustrated in FIG. 2.

Generally, the method 400 shown in FIG. 4 includes loading the data of the boot-set into the non-volatile cache prior to shutdown. FIG. 4 illustrates that the method 400 may be triggered by a shutdown notification such as that discussed above in connection with FIG. 2.

For at least one embodiment, the method 400 may be performed by a driver. When the driver receives notification of a shutdown, it typically has an opportunity to prepare for the shutdown. For at least one embodiment, the method 400 is performed by the driver as part of this shutdown preparation processing. Generally, when the driver receives a shutdown notification, it uses the shutdown preparation period as an opportunity to read from the cached device the data specified by the boot set 370 and insert in into the non-volatile cache.

More specifically, FIG. 4 illustrates that, at block 402, the data indicated by the boot set 370 is loaded into the non-volatile cache. FIG. 4 illustrates, for at least one embodiment, the loading of block 402 may be accomplished via at least two component blocks. First, at block 404 the data indicated by the boot set 370 may be read from the cached device. Then, such data may be stored in the non-volatile cache at block 406.

Processing proceeds from block 402 (or, more specifically for at least one embodiment, from block 406) to block 407. At block 407, a termination indicator is generated to indicate that boot set storage into the non-volatile cache is complete and that it is now safe to shut down the machine. Of course, one of skill in the art will recognize that the method 400 may represent only a portion of shutdown preparation processing. For at least one embodiment, other shutdown preparation processing may be performed by the driver before the termination indicator is sent at block 407. Processing then ends at block 408.

After the processing of the method 400 illustrated in FIG. 4 has been performed, the boot set data, which may be utilized during a subsequent power-up, has been stored in the non-volatile cache and will therefore be available upon a subsequent power-up.

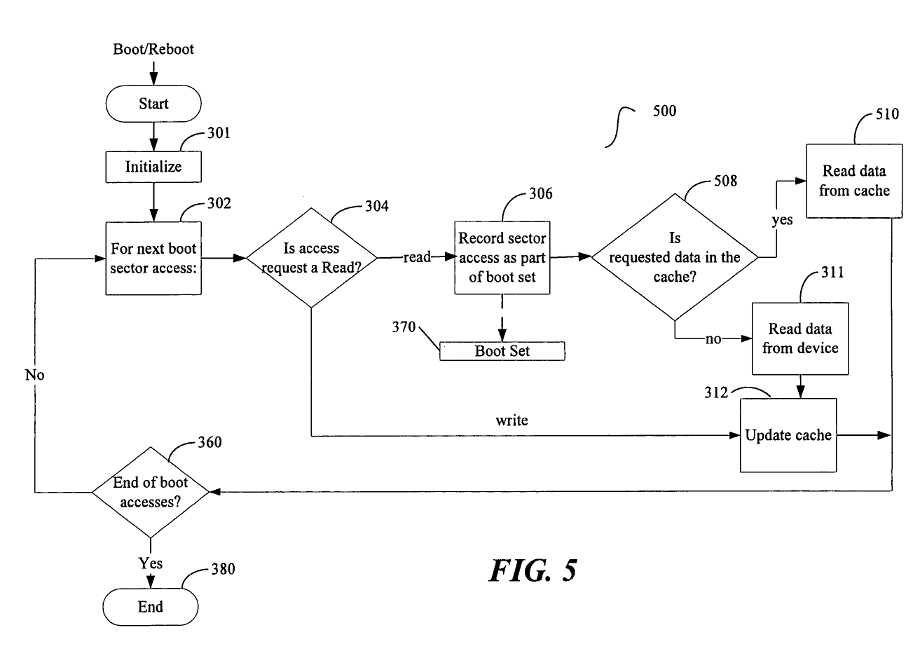

FIG. 5 is now referenced for a discussion of the processing for a subsequent power-up after a boot set has been loaded into a non-volatile cache during a previous power-down. Generally, the processing includes providing previously-cached boot data from the cache (see non-volatile cache 150), thereby avoiding an access of the cached-device during booting. In several respects, the processing for the subsequent reboot method 500 illustrated in FIG. 5 is similar to that of the initial boot method 300 illustrated in FIG. 3. Unless otherwise noted below, common reference numerals in FIGS. 3 and 5 indicate substantially similar processing (see description of FIG. 3, above).

FIG. 5 illustrates that the subsequent power-up may be triggered by a boot/reboot signal as discussed above in connection with FIG. 2. When the driver is initialized at block 301, it reads from the cache (150, FIG. 1) information about what data is stored in the cache.

As is discussed in connection with FIG. 3, above, the system may request access to boot data at block 302. If the access is determined at block 304 to be a read, processing proceeds from block 304 to block 306. If the access is a write, processing proceeds from block 304 to block 312.

At block 306, the read access may be recorded in the boot set 370, if such sector has not already been recorded in the boot set 370. In addition to recording a read access (306), the method determines 508 whether the requested read data is already in the non-volatile cache. (As is mentioned above, the driver may read which information is stored in the cache during the initialization block 301). If the requested read data is not already in the cache, it may be obtained 311 from the cached device and stored 312 in the cache, as is described above in connection with FIG. 3. From block 312, processing proceeds to block 360.

If the requested read data is already in the cache, processing proceeds from block 508 to block 510. At block 510, the requested read data is read from the cache 510, without requiring an access of the cached device. From block 510, processing proceeds to block 360.

At block 360, it is determined whether the end of the boot set has been reached. This may be done by utilizing any one or more of the techniques described above in connection with FIG. 3. Processing then loops back to block 302 (if the end of the boot set has not been reached), or ends at block 380 (if the end of the boot set has been reached).

By copying boot data into a non-volatile cache during system shutdown, the time needed for a subsequent system initialization can be reduced. Although the invention has been described with reference to a system initialization, the teachings of the invention is not limited to data used during system initialization and can be applied in any operation which requires repeated use of relatively large amounts of data that must be loaded from disk.

As used herein, a tangible computer accessible medium includes, but is not limited to portable or fixed storage devices, optical storage devices, and any other memory devices capable of storing computer instructions and/or data. Such a tangible medium may store machine-accessible data received over a propagated signal, wherein the data, when accessed, results in a machine performing a desired task or tasks. “Computer instructions” are software or firmware including data, codes, and programs that may be read and/or executed to perform certain tasks.

The foregoing embodiments are merely exemplary and are not to be construed as limiting the present invention. The present teachings can be readily applied to other types of apparatuses. The description of embodiments of the present invention is intended to be illustrative, and not to limit the scope of the appended claims. Many alternatives, modifications, and variations will be apparent to those skilled in the art.

For example, for an alternative embodiment more than one boot set may be maintained. For example, a history of boot set data may be maintained across several iterations of the methods illustrated in FIGS. 3 and 5, rather than merely maintaining a single boot set that reflects boot data from the most recent boot/reboot. For such embodiment, analysis may be performed to determine a subset of boot data that is frequently accessed during boot/reboot. Such subset of data may be loaded into the cache during each occurrence of the pre-shutdown processing stage (see 206, FIG. 2), even if one or more elements of such subset are not in the current boot set.

For at least one other alternative embodiment, different boot sets may be maintained for different types of transitions. For example, a “resume” boot set may be maintained for transitions from a hibernate state to a full power state, and a separate “initialize” boot set may be maintained for transitions from a non-powered “off” state to a full power state. Other types of specialized boot sets may be maintained for any and all other permutations of power states.

What is claimed is:

1. A method comprising:
recording a boot set during a system initialization state;
utilizing a cache memory during a runtime state; and
responsive to a shutdown notification, copying, prior to entering a shutdown state, data to the cache memory;
the data being indicated by the boot set;
the cache memory being a non-volatile storage medium; and
wherein the data indicated by the boot set may be evicted during the runtime state.

2. The method of claim 1, wherein:
the boot set further comprises a set of data accessed during the initialization state.

3. The method of claim 1, wherein:
the boot set further comprises a set of data read from a mass storage device during the initialization state.

4. The method of claim 1, wherein said recording further comprises:
receiving an access request; and
determining whether the access request is a read request.

5. The method of claim 4, wherein said recording further comprises:
if the access request is a read request, recording in the boot set an identifier for the requested read data.

6. The method of claim 5, wherein the identifier further comprises:
a start address and a data length value.

7. The method of claim 1, wherein said copying further comprises:
reading, from a mass storage device, boot data indicated by the boot set; and
storing the boot data to the non-volatile cache.

8. The method of claim 7, wherein said copying further comprises:
indicating that said storing has been completed.

9. A system comprising:
a processor;
a non-volatile cache coupled to the processor; and
logic to store initialization data in the non-volatile cache prior to a shutdown of the processor such that the initialization data will be present in the non-volatile cache during a subsequent boot of the processor.

10. The system of claim 9, wherein the shutdown further comprises removal of operational power to the processor.

11. The system of claim 9, wherein the shutdown further comprises entry into a low power state.

12. The system of claim 9, wherein the cache is implemented as an add-in card.

13. The system of claim 11, wherein the low power state is a sleep state.

14. The system of claim 9, wherein the subsequent boot further comprises a transition from a low power state to a fully operational state.

15. The system of claim 9, wherein the shutdown further comprises a warm start.

16. The method of claim 1, further comprising:
reading a datum of said data from the non-volatile cache during an initialization state subsequent to entering said shutdown state.

17. A method, comprising:
storing in a non-volatile cache at least a portion of data used during initialization of a system; and
responsive to a subsequent exit from a low-power state, permitting the portion of date to be evicted from the non-volatile cache.

18. The method of claim 17, further comprising:
accessing the portion of data in the non-volatile cache during the subsequent exit from the low-power state.

19. The method of claim 17, wherein said storing further comprises:
determining, during system initialization, the portion of initialization data; and
copying, during processing preparatory to entering the low-power state, the portion of initialization data to the non-volatile cache.

20. The method of claim 17, wherein:
said storing is performed during processing to prepare for entry into the low-power state.

21. The method of claim 19, wherein said determining further comprises:
recording memory accesses during said system initialization.

22. The method of claim 21, further comprising:
recording an identifier to indicate each memory address read during said system initialization.

23. An article comprising: a machine-accessible medium having stored thereon data representing sequences of instructions which, when executed by a machine, cause the machine to:
determine, during system initialization, a set of initialization data;
copy, during processing preparatory to entering a low-power state, the set of initialization data to a non-volatile cache; and
responsive to a subsequent exit from the low-power state, permitting the set of initialization to be evicted from the non-volatile cache.

24. The article of claim 23, wherein the data representing sequences of instructions which, when executed by a machine, cause the machine to determine a set of initialization data, further cause the machine to record one or more identifiers for data accessed during the system initialization.

25. The article of claim 23, wherein the low power state is an off state.

26. The article of claim 23, wherein the low power state is a sleep state.

27. The article of claim 23, further having stored thereon data representing sequences of instructions which, when executed by a machine, cause the machine to:
access the set of initialization data from the non-volatile cache during the subsequent exit from the low-power state.
